(19) United States
(12) Patent Application Publication
(10) Pub. No.: US 2004/0057713 A1
(43) Pub. Date: Mar. 25, 2004

(54) Camera and camera system

(76) Inventors: Masanori Ishikawa, Tokyo (JP); Toru Kawai, Kanagawa (JP); Seiichi Kashiwaba, Tochigi (JP); Shigeki Sato, Tochigi (JP)

Correspondence Address: MORGAN & FINNEGAN, L.L.P., 345 PARK AVENUE, NEW YORK, NY, 10154, US

(21) Appl. No.: 10/665,077

(22) Filed: Sep. 16, 2003

(30) Foreign Application Priority Data
Sep. 19, 2002 (JP) 2002-274004

(51) Int. Cl. G03B 3/00

(52) U.S. Cl. 396/89

(57) ABSTRACT

A camera which optimally corrects focus variations caused by stopping down of the stop, is disclosed. The camera comprises a focus detection unit and a controller which controls the driving of the focus lens. The controller drives the focus lens based on the detection result from the focus detection unit when the stop is in a first state. Then, the controller sets the stop in a second state and drives the focus lens based on the detection result from the focus detection unit in the second state.

### BACKGROUND OF THE INVENTION

1. Field of the Invention

The present invention relates to a camera with an autofocusing function.

2. Description of the Related Art

An image-taking optical system normally involves spherical aberration or axial chromatic aberration, therefore it is difficult to acquire ideal image formation through an image-taking optical system. Furthermore, an optimum image plane which has the highest image-forming performance varies depending on the aperture value.

A conventional camera normally detects a focusing state (focus detection) of an image-taking optical system in a full aperture state, and therefore performs a focusing operation so that the optimum image plane matches the film plane or light-receiving plane of an image pickup element in the full aperture state. Therefore, stopping down the diaphragm improves the performance on the entire screen, but since the image-taking optical system has spherical aberration, when the diaphragm is stopped down, the position of the optimum image plane has moved in the direction of the optical axis and has deviated from the film plane or light-receiving plane of the image pickup element. That is, the focus variations are caused when the diaphragm is stopped down.

Especially due to high power of recent image-taking zoom lenses, the height of a light beam that passes through each lens unit varies drastically by variable power and spherical aberration also varies drastically. For this reason, variations in the optimum image plane caused by stopping down the diaphragm are also increased by variable power.

A technology for correcting focus variations caused by stopping down a diaphragm is proposed in Japanese Patent Laid-Open Application No. H9(1997)-061703.

A camera proposed in this Japanese Patent Application Laid-Open determines an amount of focusing through calculations using focal length data corresponding to the focal length of an image-taking optical system, diaphragm data corresponding to the diaphragm diameter of the aperture diaphragm and a prestored predetermined correction coefficient, drives the focus lens by the amount of focusing or by adding the amount of focusing to the focus detection result and thereby corrects a focus variation of the optimum image plane with respect to the film plane caused by the variation in the diameter of the diaphragm over the entire variable power area.

However, in the correction of focus variation through stopping down the diaphragm, the amount of focusing is determined based on the stored correction coefficient data, which requires a memory to store the correction coefficient data.

Furthermore, when the amount of focusing is changed according to the focal length of an image-taking optical system, the amount of focusing varies due to detection errors of an encoder, etc., which detects the focal length or manufacturing errors of the image-taking lens.

Furthermore, there is a time lag from focus detection to the start of image taking in order to carry out image-taking preparations such as stopping down of the diaphragm after focus detection and especially when an image of a moving object is taken, the in-focus accuracy during image taking may not always be guaranteed.

On the other hand, when focus detection is performed after the diaphragm is stopped down, the amount of light used for focus detection from an object is smaller compared to a case where focus detection is performed in the full aperture state, and therefore a charge storage time of a focus detection sensor (e.g., CCD line sensor) is extended. As a result, the time until focusing is achieved extends, repressing speeding up of autofocusing.

### SUMMARY OF THE INVENTION

It is an object of the present invention to provide a camera and camera system adapted to be able to eliminate the need for a memory to store data for correcting focus variations by stopping down the stop and optimally correct focus variations by stopping down the stop without repressing speeding up of focusing.

One aspect of the camera of the present invention comprises a focus detection unit which detects a focusing state of an image-taking optical system and a controller which sends data and a signal to a lens apparatus through a communication unit. The controller sends data for driving the focus lens to the lens apparatus based on the detection result from the focus detection unit when the stop is in a first state. Then, the controller sends a signal for setting the stop in a second state in which the stop is stopped down more than in the first state to the lens apparatus and sends data for driving the focus lens to the lens apparatus based on the detection result from the focus detection unit in the second state.

A second aspect of the camera of the present invention comprises first and second focus detection units which detect a focusing state of the image-taking optical system based on mutually different detection systems and a controller which sends data and a signal to the lens apparatus through the communication unit. The controller sends data for driving the focus lens to the lens apparatus based on the detection result from the first focus detection unit when the stop is in the first state. Then, the controller sends a signal for setting the stop in the second state in which the stop is stopped down more than in the first state to the lens apparatus and sends data for driving the focus lens to the 1 ns apparatus based on the detection result from the focus detection unit in the second state.

A third aspect of the camera of the present invention comprises a focus detection unit which detects a focusing state of the image-taking optical system and a controller which controls the driving of the focus lens. Here, the controller drives the focus lens based on the detection result from the focus detection unit when the stop is in the first state. Then, the controller sets the stop in the second state in which the stop is stopped down more than in the first state and drives the focus lens based on the detection result from the focus detection unit in the second state.

A fourth aspect of the camera of the present invention comprises first and second focus detection units which detect a focusing state of the image-taking optical system based on mutually different detection systems and a controller which controls the driving of the focus lens. The controller drives the focus lens based on the detection result from the first focus detection unit when the stop is in the first state. Then, the controller sets the stop in the second state in which the stop is stopped down more than in the first state and drives the focus lens based on the detection result from the second focus detection unit in the second state.

One aspect of the camera system of the present invention comprises the above described camera and a lens apparatus mounted on the camera, the lens apparatus comprising an image-taking optical system including a focus lens and a stop.

The features and advantages of the camera and camera system of the invention will become more apparent from the following detailed description of preferred embodiments of the invention with reference to the drawings.

### BRIEF DESCRIPTION OF THE DRAWINGS

FIG. 1 is a sectional view of a lens interchangeable type digital camera system which is Embodiment 1 of the present invention;

FIG. 2 is a block diagram showing an electric circuit configuration of the digital camera system in FIG. 1;

FIG. 3 is a flow chart showing an operation of the camera controller of the digital camera system in FIG. 2;

FIG. 4 is a sectional view of a lens interchangeable type digital camera system which is Embodiment 2 of the present invention;

FIG. 5 is a block diagram showing an electric circuit configuration of the digital camera system in FIG. 4;

FIG. 6 is a flow chart showing an operation of the camera controller of the digital camera system in FIG. 5;

FIG. 7 is a sectional view of a lens integral type digital camera, which is a modification example of Embodiment 1 above;

FIG. 8 is a block diagram showing an electric circuit configuration of the digital camera in FIG. 7;

FIG. 9 is a sectional view of a lens integral type digital camera, which is a modification example of Embodiment 2 above; and

FIG. 10 is a block diagram showing an electric circuit configuration of the digital camera in FIG. 9.

### DETAILED DESCRIPTION OF THE PREFERRED EMBODIMENTS

With reference now to the attached drawings, embodiments of the present invention will be explained below.

(Embodiment 1)

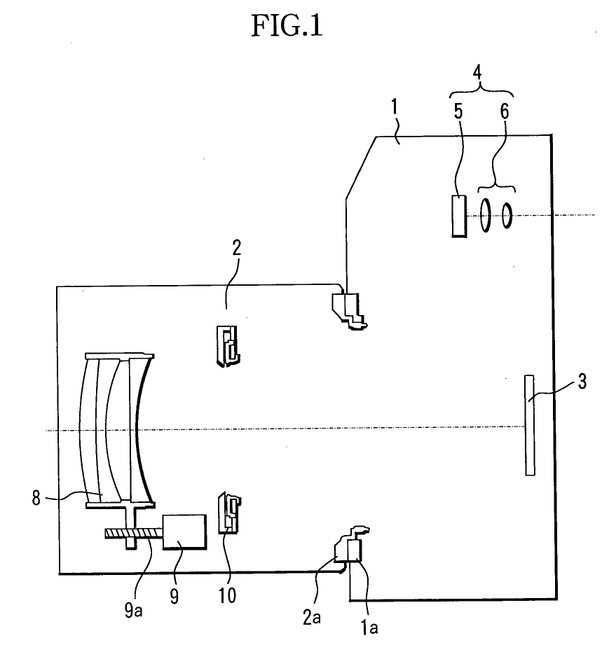

FIG. 1 shows a configuration of a lens interchangeable type digital camera system which is Embodiment 1 of the present invention.

In FIG. 1, reference numeral 1 denotes a camera, 2 denotes an interchangeable lens (lens apparatus) that can be detachably attached to the camera 1.

First, the interchangeable lens 2 is provided with an image-taking optical system including a focus lens 8, a diaphragm (stop) 10 and other lenses (not shown). Reference numeral 9 denotes a focus motor as an actuator for driving the focus lens 8 in the direction of the optical axis and drives the focus lens 8 in the direction of the optical axis by rotating a lead screw 9a which is integral with the output shaft. This embodiment uses a stepping motor as the focus motor 9.

Reference numeral 2a denotes a lens side mount which is coupled with a mount 1a of the camera 1 in a detachable manner and is provided with a lens contact unit as a communication unit which will be described later.

In the camera 1, reference numeral 3 denotes an image pickup element which photoelectrically converts an image of an object formed by the image-taking optical system of the interchangeable lens 2, captures an image for image taking and also serves as a focus detection sensor. This image pickup element 3 is constructed of a CCD or CMOS sensor, etc.

Reference numeral 4 denotes a finder display system, which is constructed of a liquid crystal display element 5 and an optical system 6 which allows the photographer to observe an image displayed on the liquid crystal display element 5. The liquid crystal display element 5 displays the image captured by the image pickup element 3.

Here, focus detection using the image pickup element 3 as a focus detection sensor will be explained. The image pickup element 3 includes micro lenses which are arranged two-dimensionally on the front and each micro lens is provided with a pair of photoreception portions. Then, the photoreception portion is projected through the micro lens onto a pupil of the image-taking optical system, whereby the pupil is divided and two images of the same part of the object are formed on one pair of the photoreception portions. Focus detection is performed by detecting a positional phase difference between these two images based on the output of the image pickup element 3 and converting the positional phase difference to an amount of defocus of the image-taking optical system. This is called “focus detection based on a phase difference detection system.”

Furthermore, the mount 1a provided in the camera 1 is provided with a camera contact unit as a communication unit which will be described later.

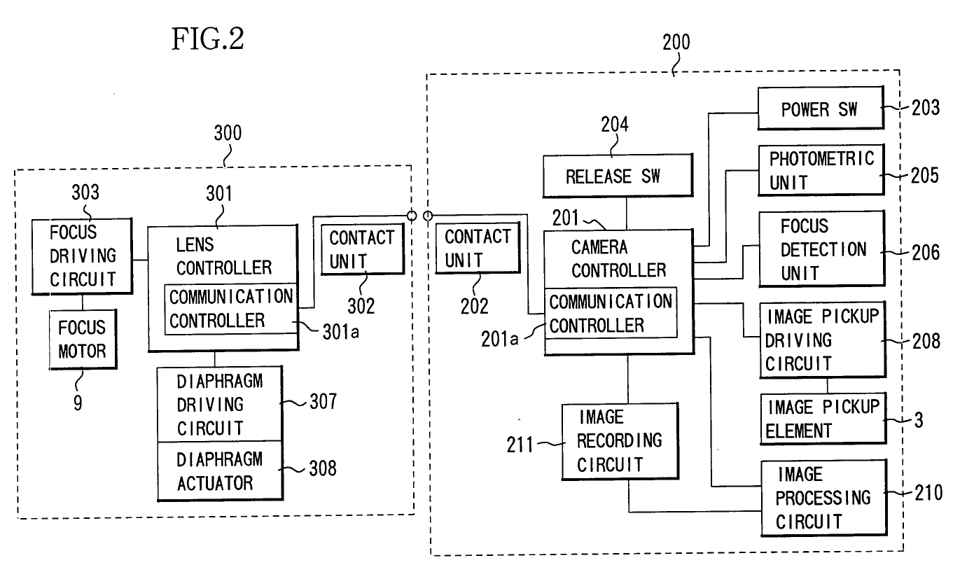

FIG. 2 shows an electrical configuration of the camera system of this embodiment. In FIG. 2, reference numeral 200 denotes an electrical circuit on the camera 1 side and 300 denotes an electrical circuit on the interchangeable lens 2 side.

In the electrical circuit 200 on the camera 1 side, reference numeral 201 denotes a camera controller constructed of a microcomputer which controls various operations of the electrical circuit 200 on the camera 1 side. Furthermore, the camera controller 201 is provided with a communication controller 201a which communicates with a lens controller 301 (communication controller 301a) through a camera contact unit 202 and a lens contact unit 302 provided in the electrical circuit 300 of the interchangeable lens 2 mounted on the camera 1.

The camera contact unit 202 includes a signal transmission contact which transmits a signal to the interchangeable lens 2 side and a power supply contact which supplies power to the interchangeable lens 2 side.

Reference numeral 203 denotes a power switch which can be operated from the outside, starts the camera controller 201 and supplies power to various circuits, actuator and sensor, etc. in the camera system, and enables the camera system to operate.

Reference numeral 204 denotes a release switch which can be operated by two-stage stroke from the outside and the signal from the release switch 204 is input to the camera controller 201. When a first stroke switch (SW1) of the release switch 204 is turned ON, the camera controller 201 allows the camera system to prepare for image taking. That is, the camera controller 201 causes a photometric unit 205 to measure brightness of an object and at the same time causes a focus detection unit 206 to perform a focus detection operation.

At this time, the diaphragm 10 is in a full aperture state (in a first state) and the focus detection unit 206 carries out focus detection with the diaphragm in the full aperture state. Then, the camera controller 201 sends a driving command of the focus lens 8 (that is, the focus motor 9) to the lens controller 301 based on the focus detection result from the focus detection unit 206 at this time.

Furthermore, when a second stroke switch (SW2) of the release switch 204 is turned ON, the camera controller 201 sends a stopping down operation command to the lens controller 301 based on the photometric result from the photometric unit 205 and causes the focus detection unit 206 to perform focus detection again after the stopping down operation of the diaphragm 10 has completed (that is, the diaphragm 10 is in a second state).

At this time, when the amount of defocus calculated based on the detection result of the focus detection unit 206 exceeds an allowable focusing value due to focus variations caused by the stopping down of the diaphragm 10, a driving command of the focus lens 8 based on the amount of defocus is sent to the lens controller 301. This allows the focus variation caused by the stopping down of the diaphragm 10 to be corrected.

The image pickup driving circuit 208 causes the image pickup element 3 to photoelectrically convert the object image according to an image pickup start command from the camera controller 201. The image signal output from the image pickup element 3 is subjected to various kinds of processing by an image processing circuit 210, and then displayed on the liquid crystal display element 5 of the finder display system 4 as an image or subjected to compression processing. An image recording circuit 211 records and saves the image data processed by the image processing circuit 210 according to a recording command from the camera controller 201 in a recording medium such as a semiconductor memory such as a flash memory, magnetic disk and optical disk, etc.

In the electrical circuit 300 on the interchangeable lens 2 side, the lens controller 301 is constructed of a microcomputer and controls various operations of the electrical circuit 300 on the interchangeable lens 2 side. Furthermore, the lens controller 301 is also provided with a communication controller 301a which communicates with the camera controller 201 (the communication controller 201a) through the camera contact unit 202 and the lens contact unit 302 provided in the electrical circuit 300 of the interchangeable lens 2 mounted on the camera 1.

The lens contact unit 302 includes a signal transmission contact which transmits a signal to the camera 1 side and a power supply contact which is supplied a power from the camera 1 side.

Reference numeral 303 denotes a focus driving circuit, which receives a driving signal from the lens controller 301 and drives the focus motor 9.

Reference numeral 308 denotes a diaphragm actuator which drives diaphragm blades (not shown) provided for the diaphragm 10 and 307 denotes a diaphragm driving circuit which receives a driving signal output from the lens controller 301 according to a diaphragm operation command sent from the camera controller 201 and drives the diaphragm actuator 308.

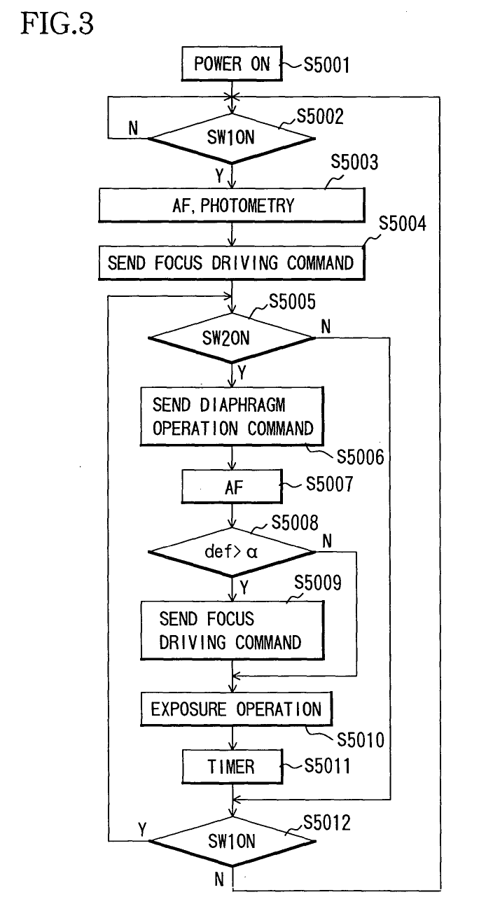

FIG. 3 shows a flow chart showing main operations of the camera controller 201.

First, when the power switch 203 of the camera 1 is turned ON, the camera controller 201 starts to operate and at the same time a power supply to the electrical circuit 300 of the interchangeable lens 2 is started (step <abbreviated as “S”> 5001). Furthermore, the camera controller 201 is enabled to communicate with the lens controller 301. Furthermore, the camera controller 201 outputs an image pickup start command to the image pickup driving circuit 208, causing the image pickup element 3 to start photoelectric conversion of an object image.

Then, the camera controller 201 judges whether an ON signal of SW1 is input or not from the release switch 204 (step 5002).

If the ON signal of SW1 has been input, the camera controller 201 causes the photometric unit 205 to perform photometry and decides an aperture value and exposure time (operation speed of a shutter (not shown) or charge storage time of the image pickup element 3) based on the output from the photometric unit 205. Furthermore, the camera controller 201 determines the amount of defocus (Def) based on the output from the focus detection unit 206 and calculates a target amount of driving of the focus lens 8 necessary to achieve focusing (actually the number of pulses indicating the amount of rotation of the focus motor 9) (step 5003).

Then, the data corresponding to the calculated target amount of driving (including the driving direction) of the focus lens 8 is sent to the lens controller 301 as a focus driving command (step 5004). The lens controller 301 that has received the focus driving command drives the focus motor 9 through the focus driving circuit 303 by the above described target amount of driving. The amount of rotation of the focus motor 9 is detected by counting pulse signals output from a rotation detection unit (not shown) according to the rotation of the motor and the motor 9 is driven so that the pulse count value reaches the number of pulses of the above described target amount of driving. This makes it possible to achieve focusing when the diaphragm 10 is in a full aperture state.

Then, the camera controller 201 judges whether an ON signal of SW2 is input from the release switch 204 or not (step 5005). If the ON signal of SW2 is not input, the process moves on to step 5012, where if it is judged that no ON signal of SW1 is input, either, the process moves back to step 5002. Furthermore, if it is judged in step 5012 that the ON signal of SW2 is not input but the ON signal of SW1 is input, the process moves back to step S5005.

On the other hand, when it is judged in step 5005 that the ON signal of SW2 is input, the camera controller 201 sends a diaphragm operation command for stopping down the diaphragm 10 so as to reach the aperture value decided in step 5003 to the lens controller 301 (step 5006). The lens controller 301 which has received the diaphragm operation command drives the diaphragm actuator 308 through the diaphragm driving circuit 307 and stops down the diaphragm 10 to the aperture value decided above.

Then, the camera controller 201 determines the amount of defocus (Def) based on the output from the focus detection unit 206 (step 5007). The amount of defocus determined here includes the amount corresponding to the focus variation caused by the stopping down of the diaphragm 10.

Then, the camera controller 201 compares the amount of defocus (Def) determined in step 5007 with an allowable focusing value (α) and judges whether focusing is achieved or not (step 5008). Here, if the amount of defocus (Def) is greater than the allowable focusing value (α), that is, it is judged that focusing is not achieved, the process progresses to step 5009, where a target amount of driving of the focus lens 8 is calculated so that the amount of defocus (Def) falls below the allowable focusing value (α) and the data of the target amount of driving (focus driving command) is sent to the lens controller 301. The lens controller 301 which has received the focus driving command drives the focus motor 9 through the focus driving circuit 303 by the above described target amount of driving. This makes it possible to achieve focusing in a state that the diaphragm 10 has been stopped down to an aperture value appropriate for image taking.

Here, the camera system in this embodiment performs focus detection again after the diaphragm 10 is stopped down and drives the focus lens 8. The deviation from the in-focus position of the focus lens 8 at this time can be considered very small because an in-focus state is mostly already achieved through first focus detection and driving of the focus lens. Therefore, the amount of driving of the focus lens 8 through the second focus detection is extremely small and will not impair speeding up of autofocusing.

When the amount of defocus (Def) in step 5008 is equal to or lower than the allowable focusing value (α), focusing is already achieved, and therefore the process progresses to step 5010.

In step 5010, the camera controller 201 allows the image recording circuit 211 to record the image data photoelectrically converted by the image pickup element 3 and processed by the image processing circuit 210 in the above described recording medium. Then, the camera controller 201 mesures a predetermined time using a timer in the camera controller 201 (step 5011) and then returns to the process in step 5005 if the ON signal of SW1 is input in step 5012 or returns to the process in step 5002 if ON signal of SW1 is not input.

In this way, the above described series of operations is repeated until the power switch 203 is turned OFF and when the power switch 203 is turned OFF, the camera controller 201 terminates the communication with the lens controller 301 and stops the operation. The power supply from the camera 1 to the interchangeable lens 2 is also terminated.

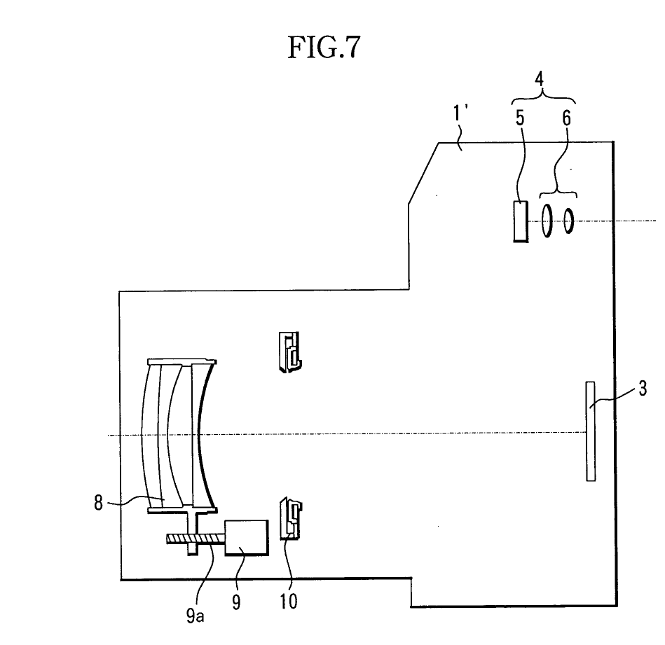

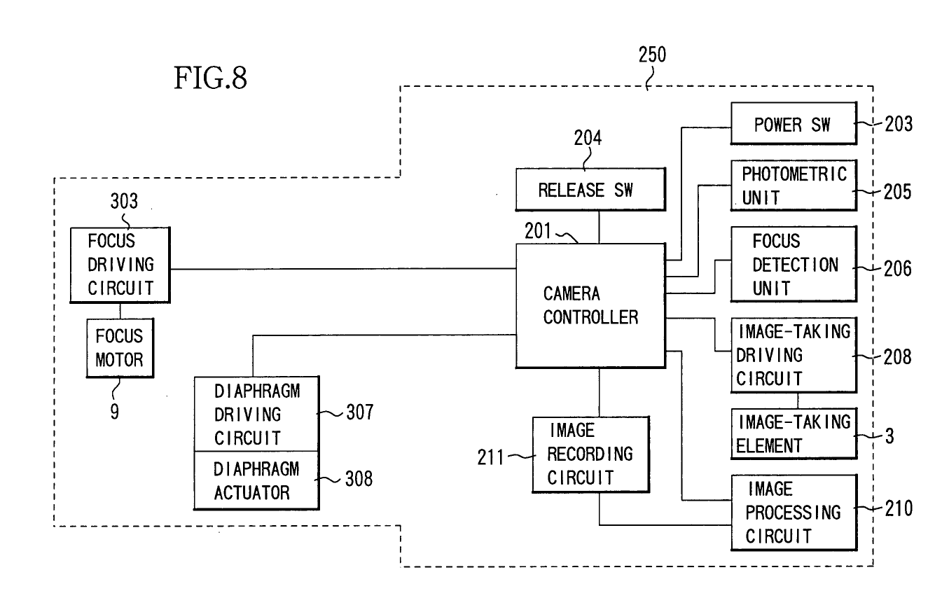

This embodiment has described the lens interchangeable type digital camera system, but the present invention is also applicable to a lens integral type digital camera 1′ shown in FIG. 7 and FIG. 8. In FIG. 8, reference numeral 250 denotes an electrical circuit in the digital camera 1′. In this digital camera 1′ (the electrical circuit 250), the same components as those in Embodiment 1 are assigned the same reference numerals as those in Embodiment 1.

In this case, the camera controller 201 having the lens controller function of Embodiment 1 drives the focus lens 8 based on the detection result from the focus detection unit 206 when the diaphragm 10 is in a full aperture state, then stops down the diaphragm 10, judges whether focusing is achieved or not based on the detection result from the focus detection unit 206 in this stopped-down state and when it judges that focusing is not achieved, the camera controller 201 drives the focus lens 8 based on the focus detection result in this stopped-down state to achieve a final in-focus state.

(Embodiment 2)

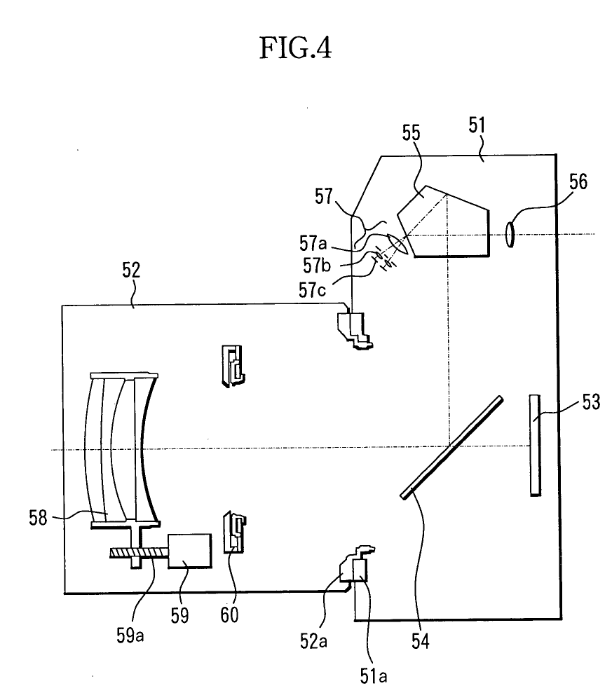

FIG. 4 shows a structure of a lens interchangeable type digital camera system, which is Embodiment 2 of the present invention.

In FIG. 4, reference numeral 51 denotes a camera and 52 denotes an interchangeable lens (lens apparatus) that can be detachably attached to the camera 51.

First, the interchangeable lens 52 is provided with an image-taking optical system including a focus lens 58 and diaphragm (stop) 60. Reference numeral 59 denotes a focus motor as an actuator which drives the focus lens 58 in the direction of the optical axis. In this embodiment, a stepping motor is used as the focus motor 59 and the focus lens 58 is driven by a lead screw 59a which is integral with the output shaft of the focus motor 59. Reference numeral 52a is a lens-side mount which is coupled with a mount 51a of the camera 51 in a detachable manner and is provided with a lens contact unit as a communication unit which will be described later.

With regard to the camera 51, the mount 51a of the camera 51 is provided with a camera contact unit as a communication unit which will be described later.

Reference numeral 53 denotes an image pickup element which photoelectrically converts an object image (optical image) formed by the image-taking optical system of the interchangeable lens 52, captures an image for image taking and also serves as a focus detection sensor which detects focusing state by means of a contrast detection method. This image pickup element 53 is constructed of a CCD or CMOS sensor, etc.

Focus detection according to the contrast detection method is performed by extracting a high frequency component from an image signal output from the image pickup element 53. Then, focusing is achieved by moving the focus lens 58 so that the peak of the high frequency component reaches a maximum. In the case of this embodiment, focus detection by means of a phase difference detection method is performed using part of the image taking light flux led into the finder optical system at a system different from the image taking system, while focus detection by means of a contrast detection method is performed using the image pickup element 53 for capturing the image taken as a sensor, and therefore it can perform focus detection with extremely high accuracy compared with the above described phase difference detection type focus detection.

Reference numeral 54 denotes a quick return mirror which is constructed of a half mirror. The quick return mirror 54 is placed on the image-taking optical path before image taking and reflects part of the light flux from the image-taking optical system toward the image pickup element 53 and the rest of the light flux toward the finder optical system. On the other hand, during image taking, the quick return mirror 54 moves away from the image-taking optical path.

The finder optical system is comprised of a pentaprism 55 and an eyepiece 56. The pentaprism 55 divides the incident light flux into two light fluxes, one light flux moves towards the phase difference detection type focus detection unit 57 and the other light flux moves towards the eyepiece 56. The focus detection unit 57 is comprised of a condenser lens 57a which divides the incident light flux into two light fluxes, two separator lenses 57b which cause these split light fluxes to form images again and a pair of CCD line sensors 57c which photoelectrically convert the two images formed. The principle of phase difference detection type focus detection by this focus detection unit 57 is the same as that of Embodiment 1.

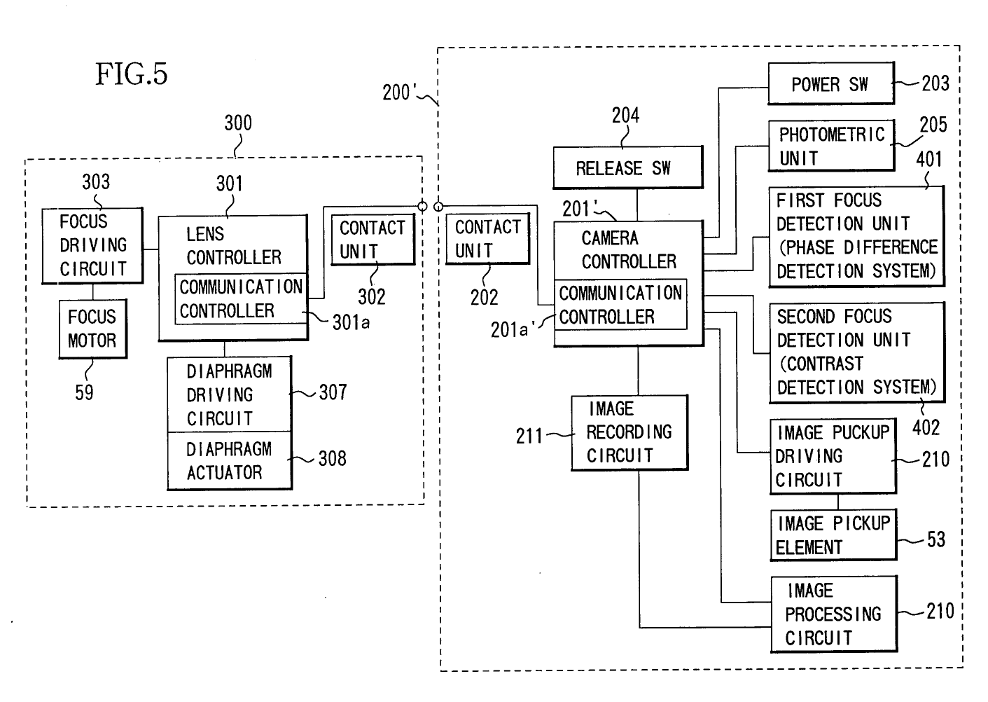

FIG. 5 shows an electrical configuration of the camera system of this embodiment. Reference numeral 200′ in FIG. 5 denotes an electrical circuit on the camera 51 side and 300 denotes an electrical circuit on the interchangeable lens 52 side. The electrical circuit 300 on the interchangeable lens 52 side is the same as that in Embodiment 1 (see FIG. 2). The same circuit components are assigned the same reference numerals as those in Embodiment 1 and explanations thereof will be omitted.

An electrical circuit 200′ on the camera 51 side differs from the electrical circuit 200 on the camera side according to Embodiment 1 in that it includes a first focus detection unit 401 which performs focus detection by means of phase difference detection method and a second focus detection unit 402 which performs focus detection by means of contrast detection method, as focus detection units and that a camera controller 201′ is constructed in such a way as to correspond to both the focus detection units 401 and 402, but the rest of the circuit configuration is the same as that of the electrical circuit 200 on the camera side in Embodiment 1. In this embodiment, the same circuit components as those in Embodiment 1 are assigned the same reference numerals as those in Embodiment 1 and explanations thereof will be omitted. The camera controller 201′ is provided with a communication controller 201a′ correspond to the communication controller 201a in Embodiment 1.

The camera 51 gets ready for image taking when a first stroke switch (SW1) of a release switch 204 is turned ON. That is, a photometric unit 205 measures brightness of an object and the first focus detection unit 401 performs a focus detection operation.

At this time, the diaphragm 60 is in a full aperture state (first state) and the first focus detection unit 401 performs focus detection when the diaphragm is in the full aperture state. Then, the camera controller 201′ sends a driving command of the focus lens 58 (that is, the focus motor 59) to the lens controller 301 based on the focus detection result at this time.

Furthermore, when the second stroke switch (SW2) of the release switch 204 is turned ON, the camera controller 201′ sends a diaphragm operation command to the lens controller 301 based on the photometry result from the photometric unit 205 and causes the second focus detection unit 402 to perform focus detection after the stopping-down operation of the diaphragm 60 is completed (that is, the diaphragm is in a second state).

At this time, a driving command of the focus lens 58 (that is, the focus motor 59) is sent to the lens controller 301 so that the detection result of the second focus detection unit 402, that is, the peak value of the high frequency component of the output signal from the image pickup element 53 reaches a maximum. In this way, focus variations caused by the stopping down of the diaphragm 60 for image taking are corrected. The subsequent operation on the camera side is the same as that of Embodiment 1.

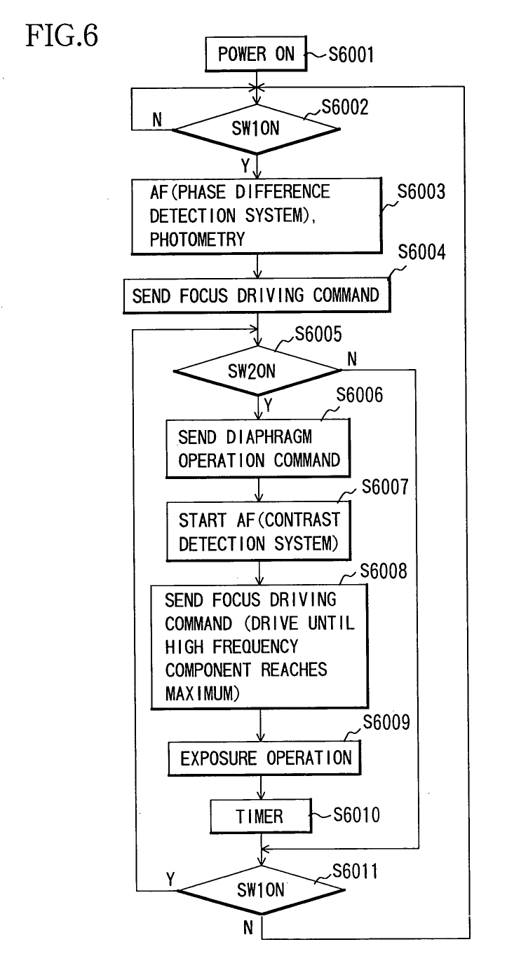

FIG. 6 shows a flow chart indicating main operations of the camera controller 201′. First, when the power switch 203 of the camera 51 is turned ON, the camera controller 201′ starts to operate and power is supplied to the electrical circuit 300 of the interchangeable lens 52 (step <abbreviated as “S” in the figure> 6001). Furthermore, the camera controller 201′ is enabled to communicate with the lens controller 301. Furthermore, the camera controller 201′ outputs an image pickup start command to the image pickup driving circuit 208 and starts to photoelectrically convert an object image by the image pickup element 53.

Then, the camera controller 201′ judges whether an ON signal of SW1 is input from the release switch 204 or not (step 6002).

If the ON signal of SW1 is input, the photometric unit 205 performs photometry and determines an aperture value and exposure time operation speed of shutter (not shown) or electric charge storage time of the image pickup element 53) based on the output of the photometric unit 205. Furthermore, the camera controller 201′ determines the amount of defocus (Def) based on the output from the first focus detection unit 402 which performs focus detection by means of a phase difference detection method and calculates the target amount of driving of the focus lens 58 necessary to achieve focusing (actually the number of pulses indicating the amount of rotation of the focus motor 59) (step 6003).

Then, the data corresponding to the calculated target amount of driving (including the driving direction) of the focus lens 58 is sent to the lens controller 301 as a focus driving command (step 6004). The lens controller 301 that has received the focus driving command drives the focus motor 59 through the focus driving circuit 303 by the above described target amount of driving. The amount of rotation of the focus motor 59 is detected by counting pulse signals output from a rotation detection unit (not shown) according to the rotation of the motor and the focus motor 59 is driven so that the pulse count value reaches the number of pulses of the above described target amount of driving. This makes it possible to achieve focusing when the diaphragm 60 is in a full aperture state.

Then, the camera controller 201′ judges whether an ON signal of SW2 is input from the release switch 204 or not (step 6005). If the ON signal of SW2 is not input, the process progresses to step 6011, where if it is judged that no ON signal of SW1 is input, either, the process returns to step 6002. Furthermore, if it is judged in step 6011 that the ON signal of SW2 is not input but the ON signal of SW1 is input, the process returns to step S6005.

On the other hand, when it is judged in step 6005 that the ON signal of SW2 is input, the camera controller 201′ sends a diaphragm operation command for stopping down the diaphragm 60 so as to reach the aperture value decided in step 6003 to the lens controller 301 (step 6006). The lens controller 301 which has received the diaphragm operation command drives the diaphragm actuator 308 through the diaphragm driving circuit 307 and stops down the diaphragm 60 to the aperture value decided above.

Then, the camera controller 201′ starts contrast type focus detection based on the output from the second focus detection unit 402 and extracts the high frequency component of the object image to evaluate the contrast of the object image formed on the image pickup element 53 (S6007). Then, until the maximum value of the high frequency component is detected, the camera controller 201′ sends a focus driving command to the lens controller 301 to drive the focus lens 58 by a predetermined amount of driving (S6008). The lens controller 301 which has received the focus driving command drives the focus motor 59 through the focus driving circuit 303 and moves the focus lens 58 by the above described predetermined amount of driving. When the maximum value of the high frequency component is detected in this way (that is, an in-focus state is detected), the process progresses to step 6009.

As described above, the camera system is this embodiment performs first focus detection in a full aperture state using the first focus detection unit, drives the focus lens based on the result of the first focus detection and then performs second focus detection using the second focus detection unit with the diaphragm stopped down to the aperture value for image taking and drives the focus lens based on the result of second focus detection to correct focusing. That is, performing first focus detection in a full aperture state and driving the focus lens based on the result of the first focus detection to shorten the charge storage time of the image pickup element, it is possible to drive the focus lens at high speed and speed up autofocusing even if the focus lens is driven while carrying out focus detection in a state where the amount of defocus is large and the in-focus position is not found.

Here, in this embodiment, focus detection (the above described second focus detection) is carried out again after the diaphragm 60 is stopped down and then the focus lens 58 is driven, but the deviation of the focus lens 58 from the in-focus position can be considered very small because an in-focus state is mostly already achieved through focus detection (the above described first focus detection) and driving of the focus lens. Therefore, the amount of driving of the focus lens 58 through the second focus detection is small, which will not impair speeding up of autofocusing.

In step 6009, the camera controller 201′ causes the image recording circuit 211 to record the image data which has been photoelectrically converted by the image pickup element 53 and processed by the image processing circuit 210 in the above described recording medium. Then, a predisposed timer is used by the camera controller 201′ to measure a predetermined time (step 6010). Then, if the ON signal of SW1 is input in step 6011, the process returns to step 6005 and if ON signal of SW1 is not input, the process returns to step 6002.

The above described series of operations is repeated until the power switch 203 is turned OFF and when the power switch 203 is turned OFF, the camera controller 201′ terminates the communication with the lens controller 301 and stops the operation. It also terminates the power supply from the camera 51 to the interchangeable lens 52.

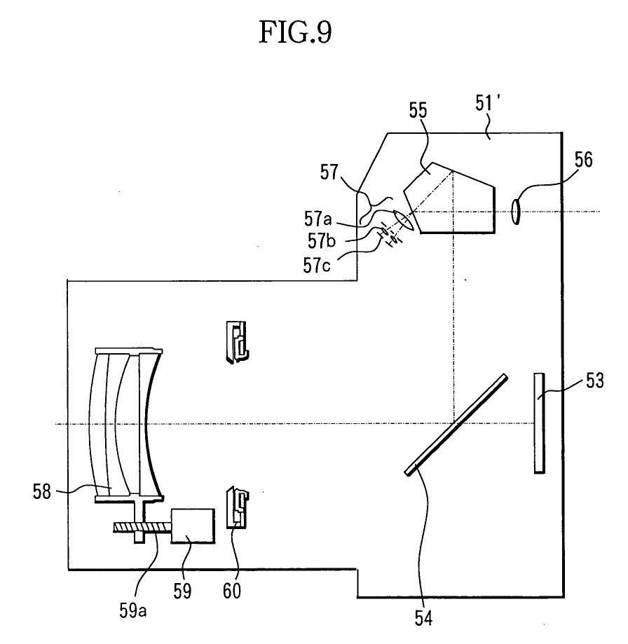

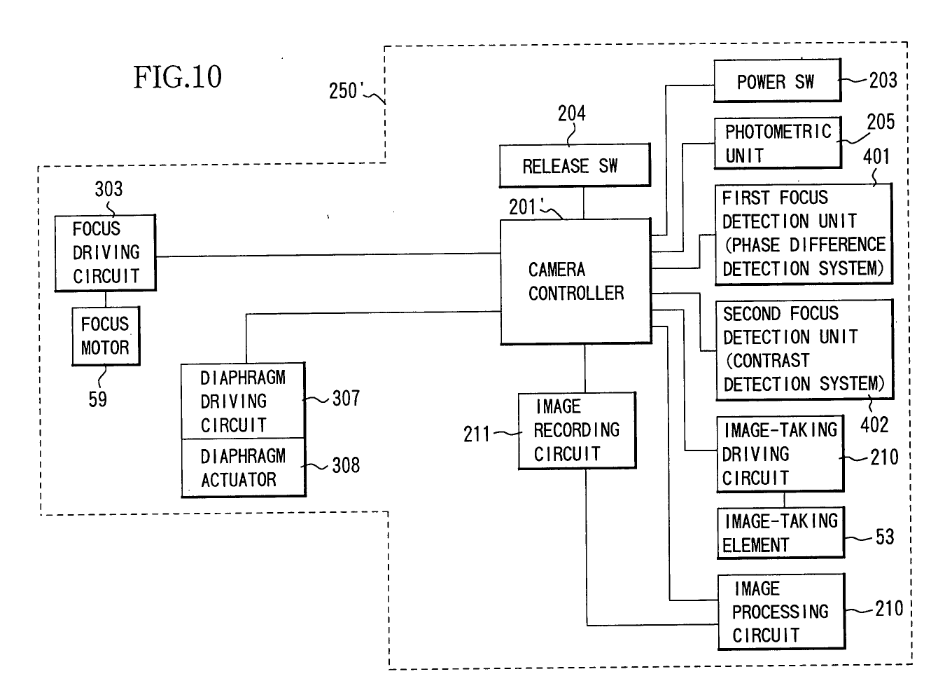

This embodiment has described the lens interchangeable type digital camera system, but the present invention is also applicable to the lens integral type digital camera 51′ shown in FIG. 9 and FIG. 10.

In FIG. 10, reference numeral 250′ denotes an electrical circuit in the digital camera 51′. In this digital camera 51′ (the electrical circuit 250′), the same components as those in Embodiment 2 are assigned the same reference numerals as those in Embodiment 2.

In this case, the camera controller 201′ having the lens controller function of Embodiment 2 drives the focus lens 58 based on the detection result from the first focus detection unit 401 when the diaphragm 60 is in a full aperture state and then stops down the diaphragm 60, drives the focus lens 58 based on the detection result from the second focus detection unit 402 when the diaphragm is in a stopped-down state and finally achieves focusing.

As described above, in the foregoing embodiments, focus detection is performed using a sufficient amount of light in a first state of the diaphragm in a short time, focusing is achieved in the first state by driving the focus lens based on the detection result and then the focus lens is driven to correct focus variations due to the stopping down of the diaphragm based on the focus detection result in the second state in which the diaphragm is stopped down more than in the first state. Therefore, there is no need for a memory which stores data to correct focus variations due to the stopping down of the diaphragm and it is possible to optimally correct focus variations due to stopping down the diaphragm without impairing speeding up of the autofocusing and improve the in-focus accuracy in the second state of the diaphragm. That is, it is possible to realize speeding up and high accuracy of autofocusing at the same time.

Furthermore, since focus detection can be carried out when preparations for image taking are substantially completed, it is possible to shorten the time from the focusing operation until image taking is started and thereby achieve focusing of a moving object with a higher level of accuracy, too.

While preferred embodiments have been described, it is to be understood that modification and variation of the present invention may be made without departing from scope of the following claims.

What is claimed is:

1. A camera on which a lens apparatus is mountable, the lens apparatus comprising an image-taking optical system which includes a focus lens and a stop, the camera comprising:
a communication unit which communicates with the lens apparatus;
a focus detection unit which detects a focusing state of the image-taking optical system; and
a controller which sends data and a signal to the lens apparatus through the communication unit,
wherein the controller sends data for driving the focus lens to the lens apparatus based on the detection result from the focus detection unit when the stop is in a first state, then sends a signal for setting the stop in a second state in which the stop is stopped down more than in the first state to the lens apparatus and sends data for driving the focus lens based on the detection result from the focus detection unit in the second state to the lens apparatus.

2. The camera according to claim 1, wherein the first state is a full aperture state and the second state is a state in which the stop is stopped down for image taking.

3. The camera according to claim 1, further comprising an image pickup element which photoelectrically converts an object image formed by the image-taking optical system, wherein the focus detection unit comprises the image pickup element as a sensor which detects the focusing state.

4. A camera on which a lens apparatus is mountable, the lens apparatus comprising an image-taking optical system which includes a focus lens and a stop, the camera comprising:
a communication unit which communicates with the lens apparatus;
first and second focus detection units which detect a focusing state of the image-taking optical system based on different detection systems; and
a controller which sends data and a signal to the lens apparatus through the communication unit,
wherein the controller sends data for driving the focus lens to the lens apparatus based on the detection result from the first focus detection unit when the stop is in a first state, then sends a signal for setting the stop in a second state in which the stop is stopped down more than in the first state to the lens apparatus and sends data for driving the focus lens based on the detection result from the second focus detection unit in the second state to the lens apparatus.

5. The camera according to claim 4, wherein the first state is a full aperture state and the second state is a state in which the stop is stopped down for image taking.

6. The camera according to claim 4, wherein the first focus detection unit detects the focusing state according to a phase difference detection system and the second focus detection unit detects the focusing state according to a contrast detection system.

7. The camera according to claim 4, further comprising an image pickup element which photoelectrically converts an object image formed by the image-taking optical system,
wherein the second focus detection unit compsises the image pickup element as a sensor which detects the focusing state.

8. A camera system comprising:
the camera according to claim 1; and
a lens apparatus mounted on the camera, the lens apparatus comprising an image-taking optical system including a focus lens and a stop.

9. A camera system comprising:
the camera according to claim 4; and
a lens apparatus mounted on the camera, the lens apparatus comprising an image-taking optical system including a focus lens and a stop.

10. A camera comprising:
an image-taking optical system which includes a focus lens and a stop;
a focus detection unit which detects a focusing state of the image-taking optical system; and
a controller which controls the driving of the focus lens,
wherein the controller drives the focus lens based on the detection result from the focus detection unit when the stop is in a first state and then sets the stop in a second state in which the stop is stopped down more than in the first state and drives the focus lens based on the detection result from the focus detection unit in the second state.

11. The camera according to claim 10, wherein the first state is a full aperture state and the second state is a state in which the stop is stopped down for image taking.

12. The camera according to claim 10, further comprising an image pickup element which photoelectrically converts an object image formed by the image-taking optical system,
wherein the focus detection unit comprises the image pickup element as a sensor which detects the focusing state.

13. A camera comprising:
an image-taking optical system which includes a focus lens and a stop;
first and second focus detection units which detect a focusing state of the image-taking optical system based on different detection systems; and
a controller which controls the driving of the focus lens,
wherein the controller drives the focus lens based on the detection result from the first focus detection unit when the stop is in a first state, then sets the stop in a second state in which the stop is stopped down more than in the first state and drives the focus lens based on the detection result from the second focus detection unit in the second state.

14. The camera according to claim 13, wherein the first state is a full aperture state and the second state is a state in which the stop is stopped down for image taking.

15. The camera according to claim 13, wherein the first focus detection unit detects the focusing state according to a phase difference detection system and the second focus detection unit detects the focusing state according to a contrast detection system.

16. The camera according to claim 13, further comprising an image pickup element which photoelectrically converts an object image formed by the image-taking optical system,
wherein the second focus detection unit comprises the image pickup element as a sensor which detects the focusing state.
